(19) United States
(12) Patent Application Publication
(10) Pub. No.: US 2025/0078377 A1
(43) Pub. Date: Mar. 6, 2025

(54) BODY TRACKING FROM MONOCULAR VIDEO

(71) Applicant: Roblox Corporation, San Mateo, CA (US)

(72) Inventors: Mubbasir Turab KAPADIA, San Mateo, CA (US); Iñaki NAVARRO OIZA, Pfaeffikon (CH); Young-Yoon LEE, Los Altos, CA (US); Joseph LIU, San Mateo, CA (US); Haomiao JIANG, Cupertino, CA (US); Che-jui CHANG, San Mateo, CA (US); Seonghyeon MOON, San Mateo, CA (US); Kiran BHAT, San Francisco, CA (US)

(73) Assignee: Roblox Corporation, San Mateo, CA (US)

(21) Appl. No.: 18/827,335

(22) Filed: Sep. 6, 2024

Related U.S. Application Data
(60) Provisional application No. 63/536,838, filed on Sep. 6, 2023.

(51) Int. Cl. G06T 13/40; G06T 7/20; G06T 7/73; G06T 7/80

(52) U.S. Cl. CPC G06T 13/40; G06T 7/20; G06T 7/73; G06T 7/80; G06T 2207/20044; G06T 2207/20084; G06T 2207/30196

(57) ABSTRACT

Various implementations relate to methods, systems and computer readable media to provide body tracking from monocular video. According to one aspect, a computer-implemented method includes obtaining a video including a set of video frames depicting movement of a human subject; extracting 2D images of the human subject from the video frames; providing the 2D images as input to a pre-trained neural network model. The method further includes determining a pose of the subject based on the 2D images. The method further includes generating a 3D pose estimation of upper body joint positions of the human subject. The method further includes determining confidence scores, and selecting a set of keypoints of the upper body joints of the human subject based on the confidence scores. The method further includes animating a 3D avatar using at least the selected set of keypoints, and displaying the animated 3D avatar in a user interface.

### CROSS-REFERENCE TO RELATED APPLICATIONS

This application claims priority under 35 U.S.C. § 119(e) to U.S. Provisional Patent Application No. 63/536,838, entitled “REAL-TIME BODY TRACKING FROM MONOCULAR VIDEO,” filed on Sep. 6, 2023, the contents of which are hereby incorporated by reference herein in its entirety.

### TECHNICAL FIELD

Implementations relate generally to computer graphics, and more specifically but not exclusively, relate to methods, systems, and computer readable media for tracking body movements of players without user-perceptible lag using a camera feed on devices that may have limited computational processing power.

### BACKGROUND

In recent years, body tracking in virtual environments has gained significant attention due to its applications in gaming, virtual reality (VR), augmented reality (AR), and human-computer interaction. Body tracking is primarily focused on capturing the movements of the human body and translating them into digital representations, such as avatars or models. Traditional body tracking approaches often rely on external hardware, such as motion capture suits or depth sensors, to capture the three-dimensional (3D) positions of the body joints. While these approaches provide high accuracy, they are costly, cumbersome, and limited to specific environments, making them impractical for widespread, real-time or near-real-time applications.

With the advent of more affordable technologies and improvements in computer vision, monocular video-based body tracking has emerged as a promising alternative. Monocular video tracking uses a two-dimensional (2D) camera, such as those found in smartphones or webcams, to estimate the body pose of a human subject. These approaches are more accessible and do not require specialized hardware, but they face significant challenges. One of the primary issues is dimensional extrapolation, where the 3D poses must be estimated from 2D input data. This process presents challenges because the depth information needed to understand spatial relationships is missing from 2D images, leading to inaccuracies in the 3D pose estimation.

Another challenge in monocular body tracking is meeting real-time or near-real-time performance constraints. Real-time or near-real-time applications, such as gaming or interactive VR environments, require pose estimations to be processed and rendered without user-perceptible lag. Many current solutions struggle with balancing computational efficiency and accuracy, often resulting in lag or delays in response to movements of the user. This is particularly problematic in mobile or low-end devices, which lack the processing power required to handle complex algorithms for 3D pose estimation and animation.

Additionally, monocular video-based techniques often face the problem of partial visibility or self-occlusion, where parts of the body are obscured by other body parts or external objects. When key joints, such as elbows or wrists, are not fully visible, existing solutions often produce erroneous predictions or fail to track the body pose entirely. These errors can lead to poor tracking performance and unreliable avatar animations. While some systems employ confidence scores to indicate the reliability of joint predictions, these approaches are often simplistic and do not adequately adjust for real-world conditions, leading to inconsistent tracking.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Implementations described herein relate to methods, systems, and computer-readable media for tracking body movements of players without user-perceptible lag using a single camera feed on devices that may have limited computational processing power.

According to one aspect, a computer-implemented method obtains a video including a set of video frames depicting movement of a human subject; extracts 2D images of the human subject from the video frames; provides the 2D images as input to a pre-trained neural network configured for upper body tracking; determines a pose of the human subject based on the 2D images, where each pose includes respective 2D positions for a set of upper body joints of the human subject; generates, by the pre-trained neural network model and based on the respective 2D positions, a 3D pose estimation of respective 3D positions of the set of upper body joints of the human subject; determines confidence scores for the set of upper body joints in the 3D pose estimation, the confidence scores representing a prediction accuracy of the 3D positions of the set of upper body joints; selects a set of keypoints of the upper body joints of the human subject based on the confidence scores; animates a 3D avatar using at least the selected set of keypoints, where the animation includes transforming coordinates of the estimated 3D joint positions to coordinates of corresponding joints of the 3D avatar; and displays the animated 3D avatar in a user interface.

In some implementations, the 3D avatar mimics the movements of the human subject based on the refined 3D pose estimation.

In some implementations, the computer-implemented method applies temporal smoothing to the 3D pose estimations across consecutive video frames of the set of video frames.

In some implementations, prior to providing the 2D image as input to the pre-trained neural network model, the computer-implemented method calibrates the 2D image to account for camera distortions.

In some implementations, the computer-implemented method triggers a re-detection of the upper body joints of the human subject in the video if the confidence scores fall below a predefined threshold.

In some implementations, joint positions of the 3D avatar are scaled to match the proportions of the human subject.

In some implementations, the pre-trained neural network model uses an attention mechanism to focus on keypoints of the upper body joints of the human subject during 3D pose estimation.

According to another aspect, a system includes one or more processors and memory coupled to the one or more processors storing instructions that, when executed by the one or more processors, cause the system to perform operations including: obtaining a video including a set of video frames depicting movement of a human subject; extracting 2D images of the human subject from the video frames; providing the 2D images as input to a pre-trained neural network model configured for upper body tracking; determining a pose of the human subject based on the 2D images, where each pose includes respective 2D positions for a set of upper body joints of the human subject; generating, by the pre-trained neural network model and based on the respective 2D positions, a 3D pose estimation of respective 3D positions of the set of upper body joints of the human subject; determining confidence scores for the set of upper body joints in the 3D pose estimation, the confidence scores representing a prediction accuracy of the 3D positions of the set of upper body joints; selecting a set of keypoints of the upper body joints of the human subject based on the confidence scores; animating a 3D avatar using at least the selected set of keypoints, where the animation includes transforming coordinates of the estimated 3D joint positions to coordinates of corresponding joints of the 3D avatar; and displaying the animated 3D avatar in a user interface.

In some implementations, the 3D avatar mimics the movements of the human subject based on the refined 3D pose estimation.

In some implementations, the instructions cause the system to further perform an operation including applying temporal smoothing to the 3D pose estimations across consecutive video frames of the set of video frames.

In some implementations, prior to providing the 2D image as input to the pre-trained neural network model, the instructions cause the system to further perform an operation including calibrating the 2D image to account for camera distortions.

In some implementations, the instructions cause the system to further perform an operation including triggering a re-detection of the upper body joints of the human subject in the video if the confidence scores fall below a predefined threshold.

In some implementations, joint positions of the 3D avatar are scaled to match the proportions of the human subject.

In some implementations, the pre-trained neural network model uses an attention mechanism to focus on keypoints of the upper body joints of the human subject during 3D pose estimation.

According to another aspect, a non-transitory computer-readable medium with instructions stored thereon is provided that, when executed by a processor, cause the processor to perform operations. The operations include: obtaining a video including a set of video frames depicting movement of a human subject; extracting 2D images of the human subject from the video frames; providing the 2D images as input to a pre-trained neural network model configured for upper body tracking; determining a pose of the human subject based on the 2D images, where each pose includes respective 2D positions for a set of upper body joints of the human subject; generating, by the pre-trained neural network model and based on the respective 2D positions, a 3D pose estimation of respective 3D positions of the set of upper body joints of the human subject; determining confidence scores for the set of upper body joints in the 3D pose estimation, the confidence scores representing a prediction accuracy of the 3D positions of the set of upper body joints; selecting a set of keypoints of the upper body joints of the human subject based on the confidence scores; animating a 3D avatar using at least the selected set of keypoints, where the animation includes transforming coordinates of the estimated 3D joint positions to coordinates of corresponding joints of the 3D avatar; and displaying the animated 3D avatar in a user interface.

In some implementations, the 3D avatar mimics the movements of the human subject based on the refined 3D pose estimation.

In some implementations, the instructions further cause the processor to perform an operation including applying temporal smoothing to the 3D pose estimations across consecutive video frames of the set of video frames.

In some implementations, prior to providing the 2D image as input to the pre-trained neural network model, the instructions further cause the processor to perform an operation including calibrating the 2D image to account for camera distortions.

In some implementations, the instructions further cause the processor to perform an operation including triggering a re-detection of the upper body joints of the human subject in the video if the confidence scores fall below a predefined threshold.

In some implementations, joint positions of the 3D avatar are scaled to match the proportions of the human subject.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of this disclosure.

### BRIEF DESCRIPTION OF DRAWINGS

FIG. 1 is a diagram of an example system architecture for body tracking from monocular video, in accordance with some implementations.

FIG. 2 is a flow diagram illustrating a method for body tracking from monocular video, in accordance with some implementations.

FIG. 3 is a diagram illustrating an example of training a neural network model for body tracking from monocular video, in accordance with some implementations.

FIG. 4 is a diagram illustrating an example of an overall pipeline for body tracking from monocular video, in accordance with some implementations.

FIG. 5 is a block diagram that illustrates an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “some implementations”, “an implementation”, “an example implementation”, etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

One or more implementations described herein relate to real-time upper body tracking from monocular video using a pre-trained neural network model. With appropriate user permission (including that from the subject), a video stream is captured consisting of multiple frames depicting the movement of a human subject. Each frame is processed to extract two-dimensional (2D) keypoints corresponding to upper body joints, such as the shoulders, elbows, and wrists. The extracted keypoints are used to estimate the three-dimensional (3D) positions of the upper body joints through a neural network-based model trained specifically for this purpose. The resulting 3D joint positions can be used to animate a virtual avatar in real-time, ensuring that the avatar's movements mirror those of the human subject.

In some implementations, an initial body detection phase is included, where a bounding box is created around the human subject in the first frame of the video. This bounding box defines the region of interest (ROI) for upper body tracking. In subsequent frames, the bounding box is dynamically adjusted based on the predicted 2D keypoints from the previous frame, which allows avoiding re-running the body detection for every frame. In some implementations, padding is added to the bounding box to improve the accuracy of the detection and alignment. In some cases, the bounding box can be adjusted to ensure proper alignment and scaling, which helps mitigate distortions caused by resizing the cropped image to the input size required by the neural network.

In some implementations, the neural network used for upper body tracking comprises several components, including a feature extraction component, a 3D head for predicting the 3D joint positions, and a SimCC head for predicting 2D poses and confidence scores. The model processes the aligned 2D image and, in some implementations, predicts both the 2D keypoints and corresponding 3D joint positions of the upper body. Confidence scores are assigned to each joint to indicate the reliability of the predicted positions, to provide a determination of when body detection should be re-triggered or when keypoints should be refined. For example, in scenarios where confidence scores fall below a certain threshold, a re-detection phase may be initiated to improve tracking accuracy. In some implementations, temporal smoothing is applied to ensure that the predictions across frames are stable and free from jitter.

In some implementations, once the 3D upper body joint positions are determined, they are used to control the animation of a virtual avatar. In some implementations, inverse kinematics (IK) are utilized to map the predicted joint positions to the avatar's skeletal structure. In some implementations, the avatar is animated in real-time, with adjustments made to bone lengths and joint positions to ensure that the avatar's movements are proportional to those of the human subject. In some implementations, certain IK chains are prioritized, such as the shoulder-to-wrist chain, to ensure that key movements, such as arm gestures, are accurately replicated in the avatar's animations.

Some technical advantages of one or more described features include addressing the challenge of dimensional extrapolation, where 3D joint positions are estimated from 2D images. A neural network is trained to predict both 2D keypoints and 3D poses based on monocular video input. By using keypoints from previous frames to estimate the bounding box for the current frame, the need for recalculating the position of a body in every frame is mitigated. This reduces the complexity of extrapolating 3D data from 2D images, ensuring accurate tracking without excessive computational overhead. This makes dimensional extrapolation more efficient and suitable for low-end devices.

Another technical advantage of some implementations is enabling near-real-time performance, i.e., lack of user-perceptible lag. This is important for body tracking in interactive environments where latency can degrade the user experience. Lightweight architectures may be employed, combined with temporal exponential smoothing to stabilize the 3D pose predictions. This allows incoming video frames to be processed quickly, making it capable of responding to near-real-time movements of the human subject without user-perceptible lag.

Another technical advantage of some implementations is in mitigating the issue of partial visibility, particularly in cases where joints are occluded or not fully visible in the 2D image. By incorporating confidence scores into the tracking process, the reliability of each predicted joint position can be determined. Even in situations of self-occlusion, the neural network model can be trained to maintain accurate predictions for visible joints while discarding unreliable keypoints with lower confidence scores.

Another technical advantage of some implementations is the enabling of more immersive experiences with enhanced animation. The use of procedural animation, combined with 3D pose data generated by the neural network, allows for highly realistic avatar control. 3D joint positions can be translated into avatar movements, providing smooth, near-real-time animation without heavy computational costs. The rescaling of bone lengths and the use of inverse kinematic chains in some implementations further refine the motions of the avatar, ensuring that the virtual representation of the user mirrors their real-world movements. This enhances the immersive experience of the user, as the avatar responds naturally to the gestures and body movements of the user without user-perceptible lag.

### System Architecture

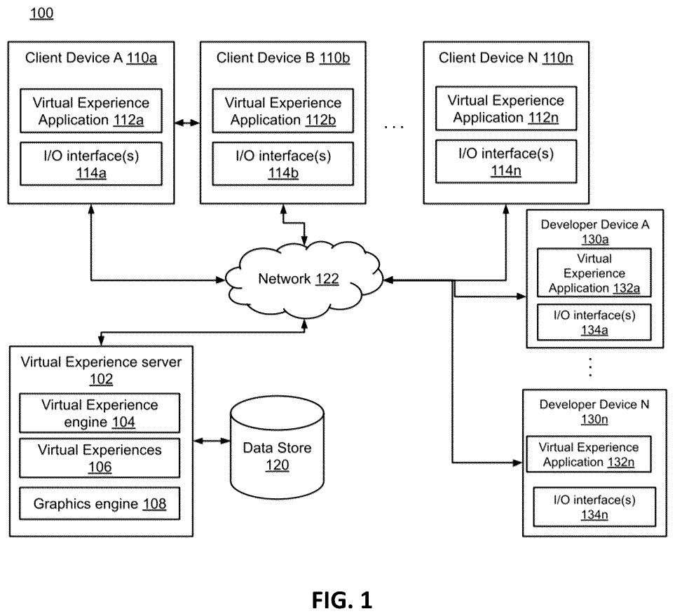

FIG. 1 is a diagram of an example system architecture that can be used for tracking body movements of players without user-perceptible lag using a single camera feed on devices that may have limited computational processing power. FIG. 1 and the other figures use like reference numerals to identify similar elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g. “110” in the text refers to reference numerals “110a,” “110b,” and/or “110n” in the figures).

The system architecture 100 (also referred to as “system” herein) includes online virtual experience server 102, data store 120, client devices 110a, 110b, and 110n (generally referred to as “client device(s) 110” herein), and developer devices 130a and 130n (generally referred to as “developer device(s) 130” herein). Virtual experience server 102, data store 120, client devices 110, and developer devices 130 are coupled via network 122. In some implementations, client device(s) 110 and developer device(s) 130 may refer to the same or same type of device.

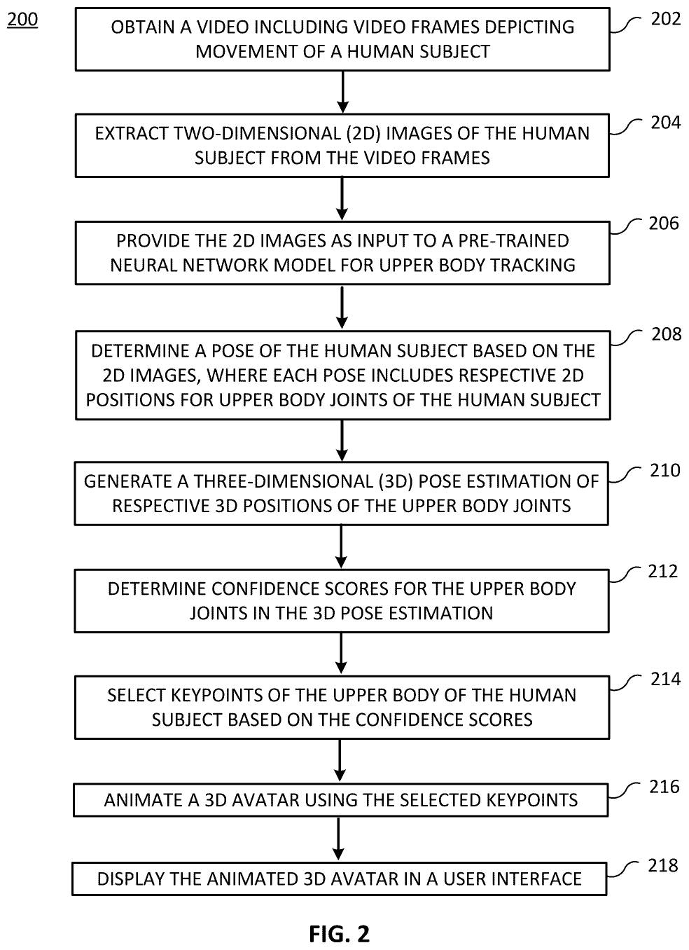

Online virtual experience server 102 can include, among other things, a virtual experience engine 104, one or more virtual experiences 106, and graphics engine 108. In some implementations, the graphics engine 108 may be a system, application, or module that permits the online virtual experience server 102 to provide graphics and animation capability. In some implementations, the graphics engine 108 may perform one or more of the operations described below in connection with the flowchart shown in FIG. 2. In one or more additional or alternative implementations, the operations described below may be performed on one or more client devices 110, or one or more developer devices 130. In some implementations, where the operations are performed depends at least in part on computational resources, e.g., memory, processing power, or disk space. A client device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, or another type of component or device capable of storing data. The data store 120 may include multiple storage components (e.g., multiple drives or multiple databases) that may span multiple computing devices (e.g., multiple server computers). In some implementations, data store 120 may include cloud-based storage.

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user with access to online virtual experience server 102. The online virtual experience server 102 may include a website (e.g., a web page) or application back-end software that may be used to provide a user with access to content provided by online virtual experience server 102. For example, users may access online virtual experience server 102 using the virtual experience application 112 on client devices 110.

In some implementations, virtual experience session data are generated via online virtual experience server 102, virtual experience application 112, and/or virtual experience application 132, and are stored in data store 120. With permission from virtual experience participants, virtual experience session data may include associated metadata, e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.

In some implementations, online virtual experience server 102 may be a type of social network providing connections between users or a type of user-generated content system that enables users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication). A record of some or all user communications may be stored in data store 120 or within virtual experiences 106. The data store 120 may be utilized to store chat transcripts (text, audio, images, etc.) exchanged between participants.

In some implementations of the disclosure, a “user” may be represented as a single individual. However, other implementations of the disclosure include a “user” (e.g., creating user) being an entity controlled by a set of users or an automated source. For example, a set of individual users federated as a community or group in a user-generated content system may be considered a “user.”

In some implementations, online virtual experience server 102 may be or include a virtual gaming server. For example, the gaming server may provide single-player or multiplayer games to a community of users that may access a “system” herein that includes online gaming server 102, data store 120, and client device 110 and/or may interact with virtual experiences using client devices 110 via network 122. In some implementations, virtual experiences (including virtual realms or worlds, virtual games, other computer-simulated environments) may be 2D virtual experiences, 3D virtual experiences (e.g., 3D user-generated virtual experiences), virtual reality (VR) experiences, or augmented reality (AR) experiences, for example. In some implementations, users may participate in interactions (such as gameplay) with other users. In some implementations, a virtual experience may be experienced in near-real-time with other users of the virtual experience.

In some implementations, virtual experience engagement may refer to the interaction of one or more participants using client devices (e.g., 110) within a virtual experience (e.g., 106) or the presentation of the interaction on a display or other output device (e.g., 114) of a client device 110. For example, virtual experience engagement may include interactions with one or more participants within a virtual experience or the presentation of the interactions on a display of a client device.

In some implementations, a virtual experience 106 can include an electronic file that can be executed or loaded using software, firmware or hardware configured to present the virtual experience content (e.g., digital media item) to an entity. In some implementations, a virtual experience application 112 may be executed and a virtual experience 106 rendered in connection with a virtual experience engine 104. In some implementations, a virtual experience 106 may have a common set of rules or common goal, and the environment of a virtual experience 106 shares the common set of rules or common goal. In some implementations, different virtual experiences may have different rules or goals from one another.

In some implementations, virtual experiences may have one or more environments (also referred to as “virtual experience environments”, “virtual environments”, or “virtual spaces” herein) where multiple environments may be linked. An example of a virtual environment may be a three-dimensional (3D) environment. The one or more environments of a virtual experience 106 may be collectively referred to as a “world” or “virtual experience world” or “gaming world” or “virtual world” or “virtual space” or “universe” herein. An example of a world may be a 3D world of a virtual experience 106. For example, a user may build a virtual environment that is linked to another virtual environment created by another user. A character (avatar) of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “virtual experience objects” or “virtual experience item(s)” herein) of virtual experiences 106.

For example, in generating user-generated virtual items, users may create characters (avatars), decoration for the characters, one or more virtual environments for an interactive virtual experience, or build structures used in a virtual experience 106, among others. In some implementations, users may buy, sell, or trade virtual experience objects, such as in-platform currency (e.g., virtual currency), with other users of the online virtual experience server 102. In some implementations, online virtual experience server 102 may transmit virtual experience content to virtual experience applications (e.g., 112). In some implementations, virtual experience content (also referred to as “content” herein) may refer to any data or software instructions (e.g., virtual experience objects, virtual experience, user information, video, images, commands, media item, etc.) associated with online virtual experience server 102 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experience applications 106 of the online virtual experience server 102 or virtual experience applications 112 of the client devices 110. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration. In some implementations, online virtual experience server 102 may host one or more media items that can include communication messages from one user to one or more other users. With user permission and express user consent, the online virtual experience server 102 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 106 may be associated with a particular user or a particular group of users (e.g., a private virtual experience), or made widely available to users with access to the online virtual experience server 102 (e.g., a public virtual experience). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or client devices 110 may include a virtual experience engine 104 or virtual experience application 112. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.) In some implementations, virtual experience applications 112 of client devices 110, respectively, may work independently, in collaboration with virtual experience engine 104 of online virtual experience server 102, or a combination of both.

In some implementations, both the online virtual experience server 102 and client devices 110 may execute a virtual experience engine (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110. In some implementations, each virtual experience 106 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two virtual experience objects, while the additional virtual experience engine functionality (e.g., generate rendering commands) may be offloaded to the client device 110. In some implementations, the ratio of virtual experience engine functions performed on the online virtual experience server 102 and client device 110 may be changed (e.g., dynamically) based on virtual experience engagement conditions. For example, if the number of users engaging in a particular virtual experience 106 meets a threshold number, the online virtual experience server 102 may perform one or more virtual experience engine functions that were previously performed by the client devices 110.

For example, users may be playing a virtual experience 106 on client devices 110, and may send control instructions (e.g., user inputs, such as right, left, up, down, user election, or character position and velocity information, etc.) to the online virtual experience server 102. Subsequent to receiving control instructions from the client devices 110, the online virtual experience server 102 may send experience instructions (e.g., position and velocity information of the characters participating in the group experience or commands, such as rendering commands, collision commands, etc.) to the client devices 110 based on control instructions. For instance, the online virtual experience server 102 may perform one or more logical operations (e.g., using virtual experience engine 104) on the control instructions to generate experience instruction(s) for the client devices 110. In other instances, online virtual experience server 102 may pass one or more or the control instructions from one client device 110 to other client devices (e.g., from client device 110a to client device 110b) participating in the virtual experience 106. The client devices 110 may use the experience instructions and render the virtual experience for presentation on the displays of client devices 110.

In some implementations, the control instructions may refer to instructions that are indicative of actions of a character (i.e., avatar) of the user within the virtual experience. For example, control instructions may include user input to control action within the experience, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a client device 110 to another client device (e.g., from client device 110b to client device 110n), where the other client device generates experience instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 110 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, characters (or virtual experience objects generally) are constructed from components, one or more of which may be selected by the user, that automatically join together to aid the user in editing.

In some implementations, a character is implemented as a 3D model and includes a surface representation used to draw the character (also known as a skin or mesh) and a hierarchical set of interconnected bones (also known as a skeleton or rig). The rig may be utilized to animate the character and to simulate motion and action by the character. The 3D model may be represented as a data structure, and one or more parameters of the data structure may be modified to change various properties of the character, e.g., dimensions (height, width, girth, etc.); body type; movement style; number/type of body parts; proportion (e.g., shoulder and hip ratio); head size; etc.

One or more characters (also referred to as an “avatar” or “model” herein) may be associated with a user where the user may control the character to facilitate an interaction of the user with the virtual experience 106.

In some implementations, a character may include components such as body parts (e.g., hair, arms, legs, etc.) and accessories (e.g., t-shirt, glasses, decorative images, tools, etc.). In some implementations, body parts of characters that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, for some asset types, e.g., shirts, pants, etc. the online virtual experience platform may provide users access to simplified 3D virtual object models that are represented by a mesh of a low polygon count, e.g., between about 20 and about 30 polygons.

In some implementations, the user may control the scale (e.g., height, width, or depth) of a character or the scale of components of a character. In some implementations, the user may control the proportions of a character (e.g., blocky, anatomical, etc.). It may be noted that is some implementations, a character may not include a character virtual experience object (e.g., body parts, etc.) but the user may control the character (without the character virtual experience object) to facilitate the interaction of the user with the virtual experience (e.g., a puzzle game where there is no rendered character game object, but the user still controls a character to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish a character of a user for view or use by other users of the online virtual experience server 102. In some implementations, creating, modifying, or customizing characters, other virtual experience objects, virtual experiences 106, or virtual experience environments may be performed by a user using a I/O interface (e.g., developer interface) and with or without scripting (or with or without an application programming interface (API)). It may be noted that for purposes of illustration, characters are described as having a humanoid form. It may further be noted that characters may have any form such as a vehicle, animal, animate or inanimate object, or other creative form.

In some implementations, the online virtual experience server 102 may store characters created by users in the data store 120. In some implementations, the online virtual experience server 102 maintains a character catalog and virtual experience catalog that may be presented to users. In some implementations, the virtual experience catalog includes images of virtual experiences stored on the online virtual experience server 102. In addition, a user may select a character (e.g., a character created by the user or other user) from the character catalog to participate in the chosen virtual experience. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a character of a user can include a configuration of components, where the configuration and appearance of components and more generally the appearance of the character may be defined by character settings. In some implementations, the character settings of a character of a user may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may be referred to as a “user device.” In some implementations, one or more client devices 110 may connect to the online virtual experience server 102 at any given moment. It may be noted that the number of client devices 110 is provided as illustration. In some implementations, any number of client devices 110 may be used.

In some implementations, each client device 110 may include an instance of the virtual experience application 112, respectively. In one implementation, the virtual experience application 112 may permit users to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual experience, etc.) served by a web server. In another example, the virtual experience application may be a native application (e.g., a mobile application, app, virtual experience program, or a gaming program) that is installed and executes local to client device 110 and enables users to interact with online virtual experience server 102. The virtual experience application may render, display, or present the content (e.g., a web page, a media viewer) to a user. In an implementation, the virtual experience application may include an embedded media player (e.g., a Flash® or HTML5 player) that is embedded in a web page.

According to aspects of the disclosure, the virtual experience application may be an online virtual experience server application for users to build, create, edit, upload content to the online virtual experience server 102 as well as interact with online virtual experience server 102 (e.g., engage in virtual experiences 106 hosted by online virtual experience server 102). As such, the virtual experience application may be provided to the client device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual experience, etc.) served by a web server. In another example, the virtual experience application may be a native application (e.g., a mobile application, app, virtual experience program, or a gaming program) that is installed and executes local to client device 110 and enables users to interact with online virtual experience server 102. The virtual experience application may render, display, or present the content (e.g., a web page, a media viewer) to a user. In an implementation, the virtual experience application may include an embedded media player (e.g., a Flash® or HTML5 player) that is embedded in a web page.

According to aspects of the disclosure, the virtual experience application 132 may be an online virtual experience server application for users to build, create, edit, upload content to the online virtual experience server 102 as well as interact with online virtual experience server 102 (e.g., provide and/or engage in virtual experiences 106 hosted by online virtual experience server 102). As such, the virtual experience application may be provided to the client device(s) 110 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual experiences 106 developed, hosted, or provided by a virtual experience developer.

In some implementations, a user may login to online virtual experience server 102 via the virtual experience application. The user may access a user account by providing user account information (e.g., username and password) where the user account is associated with one or more characters available to participate in one or more virtual experiences 106 of online virtual experience server 102. In some implementations, with appropriate credentials, a virtual experience developer may obtain access to virtual experience virtual objects, such as in-platform currency (e.g., virtual currency), avatars, special powers, accessories, which are owned by or associated with other users.

In general, functions described in one implementation as being performed by the online virtual experience server 102 can be performed by the client device(s) 110, or a server, in other implementations if appropriate. In addition, the functionality attributed to a particular component can be performed by different or multiple components operating together. The online virtual experience server 102 can be accessed as a service provided to other systems or devices through suitable application programming interfaces (hereinafter “APIs”), and thus is not limited to use in websites.

Body Tracking from Monocular Video

FIG. 2 is a flow diagram illustrating an example method 200 to provide body tracking from monocular video, in accordance with some implementations. In various implementations, the blocks shown in FIG. 2 and described below may be performed by any of the elements illustrated in FIG. 1, e.g., one or more of client devices 110 and/or virtual experience server 102. For example, in a distributed simulation, two or more client devices 110 may perform method 200, or at least one client device 110 and virtual experience server 102 may perform method 200. In some implementations, certain blocks of method 200 may be performed by a client device 110 and other blocks of method 200 may be performed by a virtual experience server 102. Method 200 begins at block 202.

At block 202, a video is obtained that includes a set of video frames depicting human movement of a human subject. In this context, the term “video” refers to a sequence of images, also known as video frames, which are captured over time. The video frames are organized in chronological order and contain visual data that represents the scene being recorded. Each video frame is a still image captured at a specific time, and together, the sequence of frames creates the perception of motion when displayed at a certain speed. The frame rate, often measured in frames per second (fps), defines the number of frames captured per second of video.

The video obtained in block 202 includes multiple video frames (a sequence of video frames), each capturing a snapshot of the environment at a specific point in time. A “video frame” refers to a single still image within the sequence, and it includes visual information such as, e.g., colors, shapes, and object locations within the captured scene. The frames may vary in resolution and quality depending on the camera specifications and environmental factors such as lighting and motion. For instance, a video captured at 30 frames per second (fps) includes 30 distinct video frames for each second of footage, where each frame depicts incremental changes in the visual data due to the movement of objects or subjects.

“Human movement” refers to the displacement or changes in position of the human body or its parts, which can occur through activities such as walking, waving, or other types of physical motion. In the video obtained at block 202, human movement is captured and reflected across the series of video frames. As the human subject moves through space, the visual data captured in each frame changes, documenting the different positions and orientations of the body of the human subject. The movement can be subtle, such as the movement of hands or facial expressions, or more pronounced, such as walking or running.

A “human subject” in this context refers to the individual whose upper body movement is being tracked within the video. Permission is obtained from the human subject prior to video capture and for analysis of the video to track body movement. The human subject occupies a portion of the video frames and is the primary object of interest. The human subject may vary in size, shape, and appearance, and can be wearing various types of clothing or accessories, all of which may affect the visual data in the video frames. The tracking system will focus on detecting and analyzing the movement of specific upper body joints such as, e.g., shoulders, elbows, and wrists, which are visible in the video frames. Block 202 is followed by block 204.

At block 204, 2D images of the human subject are extracted from the video frames. The term “extraction” as used herein refers to isolating and retrieving relevant portions of the visual data from each video frame, where the isolated data corresponds to the human subject. A 2D image is a digital representation of visual information along two axes, specifically height and width. In this context, the extracted 2D image contains visual data limited to the projection of the human subject onto a 2D plane, which can include, e.g., a shape, position, and orientation of the human subject within the frame.

Each video frame is analyzed during extraction to identify the portion of the frame containing the human subject. In various implementations, different detection techniques may be employed to differentiate the human subject from the background or other objects within the frame. In some implementations, once the human subject is detected, a bounding box or similar region of interest may be defined around the human subject in the frame, and the pixels within this region are designated as the 2D image to be extracted. In various implementations, this 2D image may consist of the entire human subject or only the portion that is visible, depending on the camera angle and occlusions present in the frame. Block 204 may be followed by block 206.

At block 206, the 2D images are provided as input to a pre-trained neural network model configured for upper body tracking. A “pre-trained neural network model”, in this context, refers to a neural network that has already been trained to perform a task, with the training being based on a dataset, prior to use of the neural network. In some implementations, training includes adjusting the parameters of the neural network, such as weights and biases, through supervised learning techniques, allowing the neural network model to be trained to predict patterns and features in the data. By being pre-trained, the neural network model can quickly generalize and apply its training to new input data, such as the 2D images of the human subject in this context.

In some implementations, the input to the pre-trained neural network model consists of the 2D images of the human subject, where each image is represented as a two-dimensional array of pixel values. The neural network processes the 2D images by analyzing the visual information in the pixel array, which includes the spatial arrangement and visual features of the human subject. In various implementations, the network processes this data through multiple layers, where each layer extracts progressively more abstract features, allowing the neural network model to be trained to predict patterns relevant to upper body tracking. In various implementations, the structure of the neural network may include convolutional layers, pooling layers, and fully connected layers, which together contribute to the ability of the neural network model to interpret visual information effectively.

“Upper body tracking” as used herein refers to the task of detecting and tracking the positions of various upper body joints, such as the shoulders, elbows, and wrists, of the human subject. The pre-trained neural network model is specifically configured for this purpose, meaning it has been optimized to focus on the visual data corresponding to the upper body joints of the human subject. The network analyzes the position and orientation of key upper body joints within the 2D images and identifies their relative positions. The configuration of the network for upper body tracking enables it to distinguish between the relevant parts of the human body and other visual elements present in the input images. After receiving the 2D images as input, the pre-trained neural network model outputs a set of 2D joint positions corresponding to the upper body joints of the human subject. In some implementations, each joint is represented as a specific point in the 2D plane of the image, as (x, y) coordinates.

In some implementations, prior to providing the 2D image as input to the pre-trained neural network model, the 2D image is calibrated to account for camera distortions. “Camera distortions” refer to any deviation or deformation in the captured 2D image caused by the inherent properties of the camera lens or sensor, such as, e.g., barrel distortion, pincushion distortion, or perspective distortion. The distortions can result in the image appearing warped or stretched, particularly near the edges, affecting the accuracy of further 3D pose estimations. In some implementations, calibration includes correcting the distortions by applying geometric transformations or adjustments to the 2D image before it is processed by the neural network. In some implementations, this is done using a pre-defined camera distortion model, which mathematically describes the specific type and degree of distortion introduced by the camera lens. In various implementations, the camera distortion model can be generated through camera calibration procedures that capture images of known reference objects, such as a checkerboard pattern, to measure how the camera distorts the image. Once the distortion model is established, the 2D image can be corrected by applying the inverse of the distortion function to straighten any warped lines. Block 206 may be followed by block 208.

At block 208, a pose of the human subject is determined based on the 2D images. Each pose includes respective 2D positions for a set of upper body joints of the human subject. In this context, pose refers to the configuration or arrangement of the body parts of the human subject at a specific moment in time, as represented in a two-dimensional space. The pose is defined by the spatial coordinates of various body joints, particularly those relevant to the upper body. In some implementations, the joints may include, but are not limited to, the shoulders, elbows, and wrists. Each joint is assigned a respective set of 2D coordinates, which specify its position within the plane of the 2D image.

In some implementations, the determination of the pose includes the identification and calculation of the 2D positions of the upper body joints in each image. The 2D position of a joint is represented by two numerical values, corresponding to its horizontal (x) and vertical (y) locations in the pixel grid of the 2D image. In some implementations, the coordinates are computed using the analysis of the neural network model of the image data, where the neural network model is trained to identify the joint locations based on the patterns it has been trained on. The 2D positions are stored in memory as arrays of coordinates, with each array representing a different joint in the upper body.

In some implementations, the set of upper body joints for which 2D positions are determined includes joints which are used for representing upper body motion and posture. For example, the set may consist of the shoulders, elbows, and wrists on both sides of the body. In some configurations, additional joints such as, e.g., the neck, upper torso, or head may be included to provide a more comprehensive representation of the upper body pose. The 2D positions of the joints form a connected structure that represents the overall posture of the human subject in the 2D image. In some implementations, this pose is determined for each frame in the video sequence. Block 208 may be followed by block 210.

At block 210, a three-dimensional (3D) pose estimation of respective 3D positions of the set of upper body joints of the human subject is generated by the pre-trained neural network model, based on the respective 2D positions. In this context, 3D pose estimation refers to determining the spatial coordinates of joints in three dimensions, namely x, y, and z axes, where the z-axis introduces depth information. In some implementations, the 3D pose estimation expands on the 2D positions computed earlier by incorporating depth data to reflect the real-world positioning and orientation of the upper body joints of the human subject.

In some implementations, the pre-trained neural network model generates the 3D pose estimation by utilizing patterns and relationships derived from the prior training of the neural network model on large datasets of annotated human poses. In various implementations, the neural network model is trained to utilize visual cues present in the 2D images, such as, for example, perspective distortion, shading, and the relative position of joints, to infer depth information. This includes computing a third coordinate, z, for each of the determined 2D joint positions, resulting in a full 3D pose for the human subject.

In some implementations, the set of upper body joints for which 3D positions are estimated includes key joints such as the shoulders, elbows, and wrists, similar to the 2D pose determination step. Each joint is represented by a set of three coordinates: (x, y, z). The x and y values correspond to the 2D positions calculated from the input images, while the z value represents the estimated depth, indicating how far the joint is from the camera or imaging plane. For example, the wrist joint in a 2D image might have coordinates (150, 200), and after the 3D estimation, it may have coordinates (150, 200, 50), where 50 indicates the distance of the wrist from the camera.

After generating the 3D pose estimation, the resulting 3D joint positions are stored in memory for further processing. The neural network model is trained to output the 3D pose as a structured array, where each element corresponds to a specific joint and contains its x, y, and z coordinates.

In some implementations, temporal smoothing is applied to the 3D pose estimations across consecutive video frames of the set of video frames. Temporal smoothing refers to adjusting the 3D pose data to reduce abrupt changes or noise that may occur between consecutive frames, resulting in a smoother and more natural representation of movement. This technique helps to mitigate potential inaccuracies or fluctuations in the 3D joint positions caused by factors such as slight variations in the pose estimation or rapid changes in the movement of the human subject. In some implementations, temporal smoothing operates by analyzing the 3D pose estimations from multiple consecutive video frames and applying algorithms to blend or average the joint positions over time. This includes using techniques such as exponential moving averages, where the current 3D pose estimation is adjusted based on a weighted combination of past pose estimations and the data of the most recent frame. By applying the techniques, the effect of sudden shifts in joint positions that may result from noisy input data can be reduced, producing a more stable and consistent representation of the movements of the subject.

In some implementations, the smoothing can be fine-tuned to balance responsiveness and stability. In cases where the movements of the human subject are slow or gradual, the smoothing function may have a greater effect, producing more pronounced smoothing over time. When the human subject makes rapid or sudden movements, the smoothing is adjusted to maintain responsiveness, ensuring that the avatar follows the motion of the human subject closely while still removing jitter in the pose data. In some implementations, the smoothing parameters are continually adjusted based on the movement characteristics of the human subject. Block 210 may be followed by block 212.

At block 212, confidence scores are determined for the set of upper body joints in the 3D pose estimation, with the confidence scores representing a prediction accuracy of the 3D positions of the set of upper body joints. Confidence score as used herein refers to a numerical value that represents the estimated reliability or accuracy of the predicted 3D position of a specific joint. Each confidence score is associated with an individual joint, such as the shoulders, elbows, or wrists, and reflects the certainty of the neural network model in the accuracy of the 3D coordinates generated for that joint. In some implementations, the confidence score can range from 0 to 1, where 1 indicates a high degree of certainty in the predicted position and 0 indicates low certainty.

In various implementations, the determination of confidence scores includes analyzing various factors that can affect the accuracy of the joint predictions. The factors may include, for example, occlusion, visibility of the joint, proximity to the camera, and the presence of overlapping body parts or objects in the 2D image. In some implementations, the confidence score for each joint is calculated based on the internal features extracted from the image and model architecture, such as the detection quality of the location of the joint in both 2D and 3D space.

In some implementations, the pre-trained neural network model uses an attention mechanism to focus on keypoints of the upper body joints of the human subject during 3D pose estimation. An attention mechanism refers to prioritizing certain parts of the input data while down-weighting less relevant parts. In this context, the attention mechanism is applied to the 2D images of the human subject to identify and focus on keypoints. In some implementations, the attention mechanism works by assigning weights to different regions of the input data, with higher weights given to areas that contain keypoints of interest.

For example, if the neural network detects that the region of the image corresponding to the shoulder of the human subject contains important information for the pose estimation, it will focus more computational resources on processing that area. The attention mechanism enables the neural network to selectively concentrate on relevant joint positions, improving the precision of the 3D pose estimation by reducing the influence of irrelevant background or noise in the image. In some implementations, during the 3D pose estimation, the attention mechanism continually analyzes the input images and updates its focus based on the movements of the human subject. As the subject moves, the neural network dynamically adjusts its attention to different keypoints, ensuring that joints are accurately tracked. The attention mechanism may prioritize joints that are more likely to influence overall body posture, such as the shoulders, or joints that are actively moving, such as the wrists during hand gestures. This selective focus helps the neural network maintain high accuracy in estimating the 3D positions of the upper body joints.

The confidence scores represent the level of certainty of the neural network model regarding the predicted positions of individual joints. In some implementations, confidence scores are utilized to trigger body detection when the certainty of joint positions falls below a predefined threshold. This threshold is heuristically determined to ensure that keypoints are only used when they are deemed reliable. If all joint confidence scores meet the threshold, the body detector is not re-run. When occlusion or poor visibility lowers the confidence scores for joints, body detection is triggered to re-localize the upper body of the human subject. This helps maintain the stability of the tracking system, reducing the likelihood of error accumulation over time when the tracking model becomes less confident about joint positions.

In some implementations, confidence scores contribute to motion refinement by allowing selective utilization of the joint predictions. When controlling a 3D avatar, joints with higher confidence scores are prioritized, ensuring that accurate predictions are used for driving the movements of the avatar. Additionally, confidence scores from previous frames may be utilized for the prediction of joint positions in subsequent frames. If a keypoint suddenly changes location or exhibits a low confidence score, the predictions can be adjusted accordingly, preventing erratic or unrealistic avatar movements.

In some implementations, confidence scores assist in calibration when initializing upper body tracking. During the setup phase, users are prompted to adjust their position relative to the camera, ensuring that their upper body is fully visible. Confidence scores are used to indicate which joints are not being accurately tracked, and a user interface can display this information to guide the user in adjusting their position. If joints such as the elbows, shoulders, or wrists have low confidence due to poor visibility, the user interface can instruct the user to move further from the camera or reposition themselves within the frame. Block 212 may be followed by block 214.

At block 214, a set of keypoints of the upper body joints of the human subject are selected based on the confidence scores. Keypoints in this context refer to specific joints or landmarks on the body of the human subject, such as, e.g., the shoulders, elbows, and wrists, which are used for tracking movement and pose. The keypoints represent locations where the joint positions are determined to have a high degree of accuracy, as indicated by the associated confidence scores. The selection of the keypoints is based on the confidence scores generated for each joint in the 3D pose estimation.

In some implementations, selecting keypoints includes analyzing the confidence scores and identifying which upper body joints have the highest confidence values. Joints with higher confidence scores are considered more reliable, meaning the predicted 3D position of the joints is likely to be accurate. As a result, the joints are prioritized and chosen as keypoints for further processing. For example, if the confidence score for the left shoulder is 0.95 and the score for the left elbow is 0.85, both joints may be selected as keypoints due to their high confidence values, indicating a reliable prediction of their positions.

In some implementations, joints with lower confidence scores, where the neural network model determines less confidence about the accuracy of the 3D positions, may not be selected as keypoints. In various implementations, the joints may have been partially occluded or less clearly visible in the input images, leading to lower confidence in their predicted positions. In some implementations, selection can include setting a confidence threshold, where joints with confidence scores meeting the threshold are chosen as keypoints. For example, a threshold of 0.8 might be applied, meaning any joint with a confidence score below this value would be excluded from the keypoint set.

In some implementations, a re-detection of the upper body joints of the human subject in the video is triggered if the confidence scores fall below a predefined threshold. Re-detection refers to re-analyzing the video frames to locate and identify the upper body joints of the human subject again, as opposed to relying on the positions of the joints. This step is initiated when the confidence scores, which represent the prediction accuracy of the 3D joint positions, are determined to fall below a certain value, indicating that the current pose estimations may no longer be reliable.

The predefined threshold is a specific confidence score value that acts as a cutoff point, below which the accuracy of the 3D pose estimations is considered insufficient. For instance, if the confidence scores for key joints such as the shoulders, elbows, or wrists drop below the threshold, it may indicate that factors such as, e.g., occlusion, poor lighting, or excessive motion have degraded the accuracy of the predictions of the neural network model. In such cases, a re-detection is triggered to obtain a more accurate analysis of the upper body joints of the human subject. In some implementations, re-detection includes performing a new search for the upper body within the video frames. In some implementations, a body detection algorithm or a 2D bounding box technique is utilized. In some implementations, the video frames are scanned to locate the region of interest that contains the upper body joints of the human subject, and new 2D images are extracted from the regions. The newly extracted images are fed back into the pre-trained neural network model to generate updated 3D pose estimations with potentially higher confidence scores. Block 214 may be followed by 216.

At block 216, a 3D avatar is animated using at least the selected set of keypoints. The animation includes transforming coordinates of the estimated 3D joint positions to coordinates of corresponding joints of the 3D avatar. The animation additionally includes mapping the 3D positions of the joints of the human subject, obtained through pose estimation, to corresponding joints in the 3D avatar model. Each joint in the upper body of the human subject that has been selected as a keypoint is associated with a corresponding joint in the avatar, which is a digital representation of a humanoid figure. The positions of the joints in the avatar are updated to reflect the estimated 3D positions of the keypoints of the human subject.

In some implementations, the transformation of coordinates includes converting the estimated 3D joint positions of the human subject into the coordinate system used by the 3D avatar. In some implementations, the joint positions of the human subject are expressed in x, y, and z coordinates, and the values are transformed to match the corresponding x, y, and z positions in the joint structure of the avatar. In various implementations, this may include scaling, rotating, or translating the coordinates depending on the relative size and orientation of the avatar compared to the human subject. For instance, if a shoulder joint of the human subject is positioned at (100, 150, 50) in real space, the shoulder joint of the avatar will be updated to reflect this position, but it may require adjustments based on the proportions of the avatar or pose constraints.

In some implementations, the animation of the 3D avatar is achieved by continually updating the positions of the joints of the avatar in near real-time, i.e., without user-perceptible lag, based on the ongoing pose estimations from the human subject. As the human subject moves, the changes in the 3D joint positions are tracked, and the changes are applied to the corresponding joints of the 3D avatar, creating the appearance of motion. In some implementations, the limbs and body parts of the avatar move in synchrony with the movements of the subject, based on the keypoints that have been selected and tracked during pose estimation. The result is a dynamic representation of the upper body motion of the human subject as reflected in the movement of the avatar.

In some implementations, additional techniques such as, e.g., interpolation or inverse kinematics may be applied to ensure smooth transitions between joint movements and to handle cases where joints that were not selected as keypoints require animation. In some implementations, missing joint movements may be filled in by estimating the intermediate positions of unsampled joints or using constraints on the skeletal structure of the avatar to ensure natural motion.

In some implementations, the 3D avatar mimics the movements of the human subject without user-perceptible lag based on the refined 3D pose estimation. User-perceptible lag as used herein refers to any delay in the display of the movements of the avatar that would be noticeable to a human observer, resulting in a mismatch between the actual movement of the human subject and the corresponding movement of the avatar. The goal is to minimize the time between the input of 3D pose estimations and the rendering of the movement of the avatar on the display. The absence of user-perceptible lag is achieved through a combination of real-time or near-real-time data processing and efficient rendering techniques.

After 3D pose estimations are generated based on the input from the pre-trained neural network, the data is immediately processed and mapped to the corresponding joints of the avatar. This transformation occurs continually as new 3D pose estimations are produced, allowing the movement of the avatar to closely track the actions of the human subject. Any delay is kept below the threshold of human perceptibility. In various implementations, the refinement of 3D pose estimations includes smoothing and filtering techniques that correct for potential noise or fluctuations in the data. The techniques operate in near-real-time to ensure that the movements of the avatar remain fluid and realistic, while avoiding any abrupt or jerky transitions that may result from rapid changes in the pose estimations. The refined 3D pose estimations serve as the primary input for controlling the joint movements of the avatar, ensuring that the avatar responds to even subtle changes in the posture of the human subject.

In some implementations, joint positions of the 3D avatar are scaled to match the proportions of the human subject. Scaling refers to adjusting the size and length of the limbs and joints of the 3D avatar so that they are proportional to the corresponding joints of the human subject. The proportions of the human subject are determined based on the relative distances between the joints of the human subject, such as the distance between the shoulders, elbows, and wrists, and the proportions are applied to the avatar to ensure accurate representation.

In some implementations, scaling includes analyzing the measured distances between the joints of the human subject in the 3D pose estimation and comparing them to the default proportions of the 3D avatar model. The avatar may have predefined joint lengths and body proportions that differ from the human subject being tracked. In some implementations, to align the appearance of the avatar with that of the human subject, the joint positions of the avatar are adjusted by applying a scaling factor. For example, if the distance between the shoulders of the subject is wider than the default avatar, the scaling factor would increase the width of the shoulders of the avatar to match the human subject.

In some implementations, scaling is performed for all relevant joints of the 3D avatar to create a proportional match with the body structure of the human subject. The scaling factor is calculated individually for each segment of the body, such as the upper arms, lower arms, and torso, based on the corresponding measurements from the human subject. In some implementations, the scaling operation adjusts the skeletal structure of the avatar while maintaining the relative positioning of the joints to preserve the integrity of the animation of the avatar. Block 216 may be followed by block 218.

At block 218, the animated 3D avatar is displayed in a user interface. A user interface refers to a graphical or visual environment through which users can interact with and view digital content, in this case, the animated 3D avatar. In various implementations, the user interface may be part of a larger software application or system that is responsible for processing, displaying, and potentially interacting with the movement of the avatar. The user interface is responsible for rendering the animation of the avatar, based on the transformation of the 3D joint coordinates, and presenting it in a way that is accessible to the user.

In some implementations, displaying the avatar includes rendering the avatar in near real-time, using the 3D positions of the keypoints to update the appearance and motion of the avatar on the screen. Rendering refers to converting the digital 3D data of the avatar, which includes its geometry, texture, and joint positions, into a 2D visual representation that can be displayed on a monitor or other output device. In some implementations, the rendering engine within the user interface takes the joint positions of the avatar, applies them to the skeletal structure of the avatar, and generates the corresponding visual output, which appears as a moving 3D figure on the screen.

In various implementations, the user interface may provide additional features for interacting with the animated avatar, such as, for example, the ability to change the viewpoint or camera angle, zoom in or out, or manipulate the environment in which the avatar is displayed. In some implementations, the interface enables users to control or interact with the avatar in near real-time, without user-perceptible lag, depending on the specific application or system. The movements of the avatar, derived from the keypoints of the human subject, are updated dynamically in the user interface as new pose estimations are generated and applied to the avatar. This provides the user with a continual view of the motion of the avatar as it mirrors the movements of the human subject.

In some implementations, one or more of blocks 202-218 may be performed by one or more server devices, and one or more of blocks 202-218 may be performed by one or more client devices. In some implementations, all of method 200 may be performed by a server device, or by a client device. In some implementations, block 216 or block 218 may be omitted. In some implementations, one or more of blocks 202, 204, and 206 may be performed in parallel. In some implementations, one or more of blocks 208, 210, 212, and 214 may be performed in parallel. In some implementations, blocks 216 and 218 may be performed in parallel.

Training a Neural Network Model for Body Tracking from Monocular Video

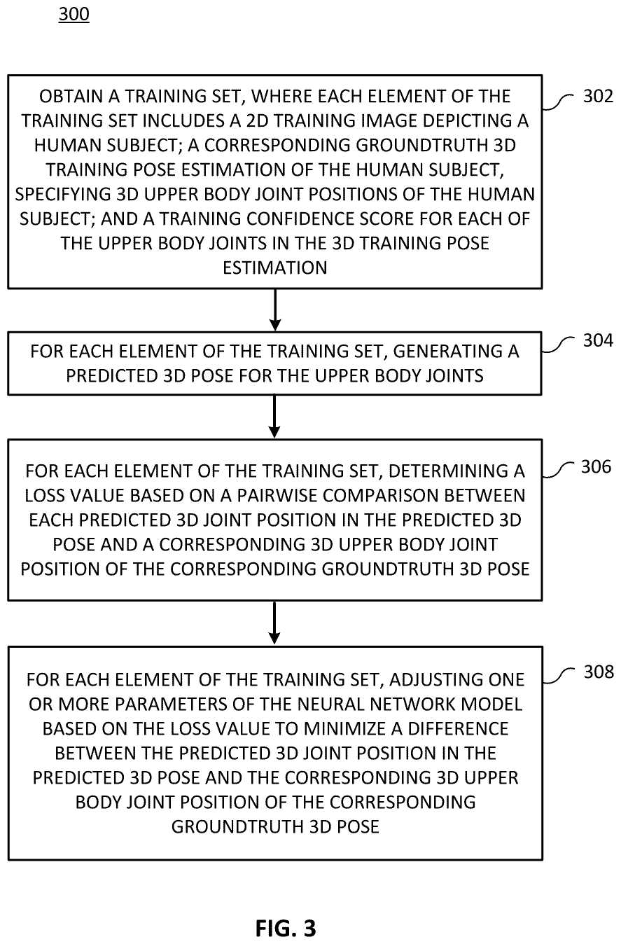

FIG. 3 illustrates a method 300 of training a neural network model for body tracking from monocular video, in accordance with some implementations. In various embodiments, the blocks shown in FIG. 3 and described below may be performed by any of the elements illustrated in FIG. 1. Method 300 begins at block 302.

At block 302, a training set is obtained, where each element of the training set includes: a 2D training image depicting a human subject; a corresponding groundtruth 3D training pose estimation of the human subject, specifying 3D upper body joint positions of the human subject; and a training confidence score for each of the upper body joints in the 3D training pose estimation, indicating accuracy of the 3D position. To train the neural network model for upper body tracking, a training set is obtained. Each element of the training set consists of several components. A 2D training image is a digital representation of a scene containing a human subject, captured in two dimensions along the x and y axes. The images provide visual data about the subject, including spatial information on the position and orientation of body parts within the image.

In various implementations, the 2D training images can be real-world images or synthetically generated images, depending on the nature of the dataset. Synthetic images are artificially created images that simulate real-world scenes and objects, in this case, depicting a human subject. The images are not captured through imaging devices like cameras but are generated using computer graphics techniques, including rendering and simulation.

The synthetic images are designed to resemble actual 2D images of human subjects and are used in place of or in addition to real-world images for training the neural network model. In various implementations, synthetic data may provide full control over a camera view and human pose in order to augment real-world datasets, such as arm-crossing and boxing poses. Synthetic data may render images with annotations. In some implementations, the neural network is trained on a combination of both synthetic and real-world datasets to improve model performance and generalizability.

In some implementations, the 2D training images in the training set are extracted from respective frames of a video depicting movement of the human subject. Each frame in the video is a still image, and by extracting individual frames, the images can be used as input for the training of the neural network model. The extracted frames provide visual data for training the neural network model to estimate 3D poses based on the dynamic movement of the human subject.

An additional component of each element is the groundtruth 3D training pose estimation of the human subject, which refers to the correct or reference 3D positions of the upper body joints. Groundtruth means that the positions are verified and accurate, serving as a reference for comparison during training. The groundtruth 3D training pose estimation is defined by the 3D coordinates (x, y, z) for a set of key upper body joints, such as the shoulders, elbows, and wrists. The joint positions are derived from precise motion capture systems or other accurate 3D tracking technologies that provide reliable data on the pose of the human subject in real-world three-dimensional space. The training for the neural network model is guided by this groundtruth data.

Additionally, each element of the training set includes a training confidence score for each upper body joint in the 3D training pose estimation. The training confidence score represents the accuracy of the 3D position of each joint, providing a numerical value between 0 and 1, where 1 indicates the highest confidence in the accuracy of the position of the joint. This score is used during the training to provide the neural network model with the reliability of the groundtruth data for each specific joint. For example, in cases where some joints are occluded or less visible, the confidence score may be lower, indicating reduced certainty in the groundtruth 3D position of those joints.

In some implementations, a subset of the training set includes 2D training images depicting self-occlusion poses. Self-occlusion occurs when parts of the body of the human subject obscure or overlap with other parts of the body in the 2D image, resulting in partial or full obstruction of certain joints or limbs. For example, when a subject crosses their arms in front of their torso or raises one arm across their face, some upper body joints may become difficult to detect due to the occlusion caused by other body parts. The poses are challenging for pose estimation tasks, as the obscured joints cannot be directly observed in the 2D image.

The 2D images depicting self-occlusion poses are incorporated into the training set to ensure that the neural network model is trained to handle the complex scenarios. Each 2D image in this subset is labeled with a corresponding groundtruth 3D pose estimation, despite the occlusion present in the image. The groundtruth 3D pose estimations provide accurate 3D positions for all upper body joints, including those that are partially or fully occluded in the 2D image. This allows the neural network model to be trained to predict the positions of occluded joints based on contextual information from visible joints and the overall body posture.

Each element in the training set combines the 2D training image, the corresponding groundtruth 3D training pose estimation, and the training confidence scores to form a dataset for supervised learning. The 2D image provides the visual input, while the groundtruth 3D pose estimation and the confidence scores offer the correct joint positions and their accuracy for comparison with the predictions of the neural network model. In various implementations, the training set is constructed to include a wide variety of poses, body positions, and confidence score distributions to ensure the neural network model is exposed to diverse conditions during the training phase. Block 302 may be followed by block 304. Blocks 304, 306, and 308 represent substeps for training a neural network model via supervised learning.

At block 304, for each element of the training set, a predicted 3D pose for the upper body joints is generated by the neural network model, based on the 2D training image. The predicted 3D pose includes a set of predicted 3D upper body joint positions of the human subject. During the training phase, the neural network model undergoes supervised learning, where it is trained using each element from the training set. A predicted 3D pose for the upper body joints of the human subject is generated based on the provided 2D training image. The 2D training image, which consists of pixel data along the x and y axes, serves as input to the neural network model. This image contains visual information such as the posture, orientation, and the positioning of body parts of the subject.

To generate the predicted 3D pose, the neural network processes the input 2D image through multiple layers of computational units. In some implementations, the layers include feature extraction layers, where the network identifies relevant visual patterns and structures in the image, such as the shape and location of the upper body joints of the human subject. As the input passes through the layers, the neural network model is trained to extract spatial relationships between the visible joints and uses this information to predict the positions of the upper body joints in three-dimensional space. The output is a set of 3D coordinates (x, y, z) corresponding to each joint in the upper body, including joints such as the shoulders, elbows, and wrists.

The predicted 3D pose generated by the neural network model consists of the 3D coordinates, which represent the estimation of the neural network model of the upper body joint positions of the human subject. For each joint, the network outputs an (x, y, z) value, where the x and y coordinates correspond to the horizontal and vertical locations of the joint in the image, and the z coordinate represents the depth or distance from the camera. The prediction is made for each of the upper body joints specified in the training set, with all joint positions forming the complete predicted 3D pose. This pose reflects a representation of the posture of the subject in three-dimensional space, based on the visual data from the 2D training image.

The neural network model is trained to generates the 3D predictions continually for each element in the training set, refining its ability to estimate the 3D positions of upper body joints over time. Each prediction is recorded and used in further training steps to calculate a loss value, which will guide adjustments to the parameters of the neural network model. The predicted 3D pose is compared to the groundtruth 3D pose of the corresponding element in the training set, allowing the neural network model to be trained and improve its predictions through repeated iterations during the training. Block 304 may be followed by block 306.

At block 306, for each element of the training set, a loss value is determined based on a pairwise comparison between each predicted 3D joint position in the predicted 3D pose and a corresponding 3D upper body joint position of the corresponding groundtruth 3D pose. The loss value is a numerical measure that quantifies the difference between the predicted 3D pose and the groundtruth 3D pose. The term pairwise comparison refers to comparing each predicted 3D joint position with the corresponding 3D joint position from the groundtruth 3D pose. For every joint in the upper body, the predicted position (x, y, z) of the neural network model is directly compared to the true position as defined in the groundtruth data, which serves as the reference for accuracy.

In some implementations, the loss value is computed by calculating the difference between each predicted joint position and its corresponding groundtruth position. This difference is expressed as the Euclidean distance between the predicted 3D coordinates and the groundtruth 3D coordinates of the same joint. The Euclidean distance provides a scalar value that represents the spatial distance between two points in three-dimensional space. For example, if the predicted position of a wrist joint is (100, 200, 50) and the groundtruth position is (105, 195, 55), the Euclidean distance between the two points would represent the error for that joint in the prediction of the neural network model.

Once the pairwise differences for all the joints in the upper body are calculated, the overall loss value is determined by aggregating the individual differences. In some implementations, the squared differences for each joint are summed to calculate a mean squared error (MSE) loss function. This technique emphasizes larger errors by squaring the differences, meaning that larger discrepancies between the predicted and groundtruth positions contribute more significantly to the total loss value. The final loss value is an aggregate measure that reflects the overall accuracy of the prediction of the neural network model for all upper body joints in that particular element of the training set. Block 306 may be followed by block 308.

At block 308, for each element of the training set, one or more parameters of the neural network model are adjusted based on the loss value to minimize a difference between the predicted 3D joint position in the predicted 3D pose and the corresponding 3D upper body joint position of the corresponding groundtruth 3D pose. The parameters, often referred to as the weights and biases of the neural network model, influence how the neural network model is trained to process input data and generates predictions. Adjusting the parameters based on the loss value is part of the training for the neural network model, allowing predictions to improve over time.

In various implementations, adjustment is guided by optimization algorithms, such as, e.g., stochastic gradient descent (SGD) or Adaptive Moment Estimation (ADAM), which modify the parameters of the neural network model to reduce the loss value. The optimization algorithm calculates how much each parameter in the neural network model contributed to the overall loss, determining the direction and magnitude of the adjustments needed. The adjustments are made by calculating the gradient of the loss function with respect to each parameter, known as backpropagation. The gradient indicates how much the loss value will change if a particular parameter is adjusted, and the parameters are updated in the direction that reduces the loss value.

In some implementations, the amount by which the parameters are adjusted in each iteration is controlled by a hyperparameter known as the learning rate. The learning rate determines the step size for updating the parameters of the neural network model. A higher learning rate results in larger changes to the parameters, while a lower learning rate leads to smaller, more gradual updates. During the training, the optimization algorithm continually updates the parameters, iteratively improving the ability of the neural network model to predict the 3D joint positions.

As the parameters of the neural network model are adjusted based on the loss value for each training set element, the neural network model is trained to progressively reduce the difference between its predicted 3D poses and the groundtruth 3D poses. This iteration enables the neural network model to be trained on the patterns and relationships between the 2D training images and the corresponding 3D joint positions. Over multiple iterations and across the entire training set, the predictions of the neural network model become increasingly accurate, ultimately improving its performance in upper body tracking. The parameter adjustment continues until the loss value reaches a minimum or a predefined stopping criterion is met, indicating that the neural network model has been sufficiently trained.

In some implementations, one or more of blocks 302-308 may be performed by one or more server devices, and one or more of blocks 302-308 may be performed by one or more client devices. In some implementations, all of method 300 may be performed by a server device, or by a client device. In some implementations, one or more of blocks 302-308 may be performed in parallel.

Body Tracking from Monocular Video

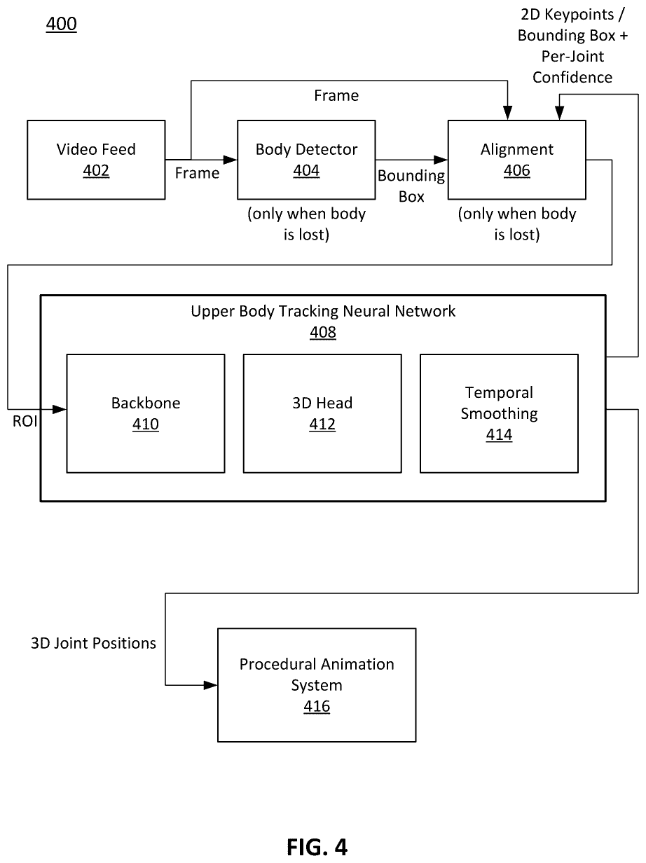

FIG. 4 is a diagram illustrating an example of an overall pipeline 400 for body tracking from monocular video, in accordance with some implementations. The overall pipeline 400 for upper body tracking consists of a pose estimation network and a procedural animation system. The network takes as input an image crop of the body to estimate 3D joint positions of the upper body (e.g., 8 upper body joints), which are provided as input to a procedural animation system. The procedural animation system uses the joint positions as control targets to animate a 3D avatar. This pipeline is configured to enable upper body tracking to be performed on low-end mobile devices while animating avatars realistically.

The overall pipeline 400 starts with a video feed 402, which serves as the input source for tracking the upper body of a human subject. The video feed 402 consists of a continual sequence of video frames, each capturing a still image of the scene that contains the human subject. The frames are processed sequentially by the components of the pipeline to extract upper body movements of the human subject.

The body detector 404 receives each frame from the video feed 402 as input. The body detector 404 is responsible for detecting the presence and location of the human subject within each video frame. The body detector 404 is used when the body is lost, i.e., not reliably detected. The body detector 404 is thus invoked selectively to reduce computational load. In various implementations, the body detector 404 can utilize various detection models capable of detecting human bodies in images with low computational requirements. The body detector outputs a bounding box around the detected human subject, which defines the region of interest (ROI) within the video frame. The smallest rectangle that bounds the predicted keypoints is used as the bounding box. Padding may be added to this rectangle to improve localization accuracy.

In some implementations, the heads for 8 upper body joints are adjusted by using a pelvis as a root and refining the bounding box to cover only the upper body. By tracking the upper body, an input size can be reduced while maintaining performance, resulting in decreased computational costs.

Once the bounding box is determined, the bounding box is passed to alignment 406, which ensures that the ROI is properly scaled and aligned for further processing. The alignment 406 adjusts the ROI, centering the human subject and ensuring that the input is properly scaled and oriented for further steps in the pipeline. The aligned ROI is passed to the upper body tracking neural network 408 to predict the upper body pose of the human subject in both 2D and 3D.

The upper body tracking neural network 408 includes multiple components, including a backbone 410, a 3D head 412, and temporal smoothing 414.

The backbone 410 is a convolutional neural network (CNN) designed to extract features from the aligned 2D input image. This backbone processes the image to identify key patterns and structures associated with the upper body joints of the human subject. The extracted features are passed to the 3D head 412, which is a 1×1 convolutional layer responsible for predicting 2D keypoints and 3D joint positions, as well as confidence scores for each joint. A heatmap from the 3D head may be utilized for determining the confidence scores. The 2D keypoints represent the locations of the upper body joints of the human subject in the 2D image.

The output from the 3D head 412 is processed through temporal smoothing 414, which reduces noise and jitter in the predicted joint positions across consecutive frames. In some implementations, temporal exponential smoothing is added to the bounding box at each frame to improve the pose prediction. Temporal smoothing 414 ensures that the estimated 3D joint positions remain stable and continuous, even in cases where the input video contains rapid movements or occlusions. The final output of the upper body tracking neural network 408 is the 3D joint positions, which represent the estimated locations of the upper body joints of the human subject in three-dimensional space.

The 3D joint positions are passed to a procedural animation system 416, which animates a virtual 3D avatar based on the estimated joint positions. The procedural animation system 416 provides a translation of the predicted joint positions into the skeletal structure of the avatar. The bone lengths of the avatar are rescaled to match the proportions of the human subject. Inverse kinematics (IK) chains are used to drive the upper body movements of the avatar, and an IK solver may be utilized. Examples of IK chains may include waist—upper torso—head, waist—upper torso—shoulder (x2), and shoulder—elbow—wrist (x2). In some implementations, the priority for the IK solver is given to the shoulder—elbow—wrist chain in order to ensure that the arm movements of the avatar closely replicate those of the human subject. The avatar can be displayed in various user interfaces, including virtual reality environments or gaming applications, providing a visual representation of the movements of the tracked subject.

### Computing Device

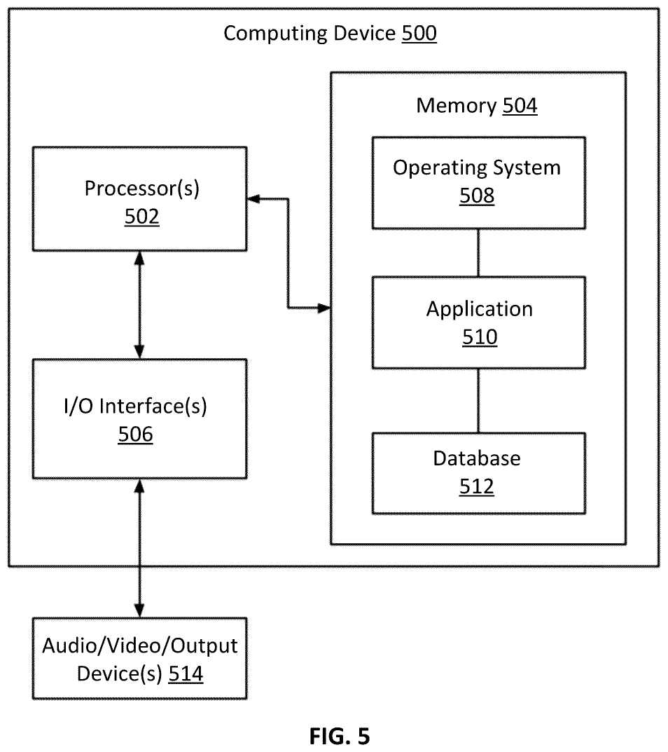

FIG. 5 is a block diagram of an example computing device 500 which may be used to implement one or more techniques described herein, including one or more techniques described with reference to FIG. 2, FIG. 3, and FIG. 4. In one example, device 500 may be used to implement a computer device (e.g., 102 and/or 110 of FIG. 1), and perform appropriate method implementations described herein. Computing device 500 can be any suitable computer system, server, or other electronic or hardware device. For example, the computing device 500 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, device 500 includes a processor 502, a memory 504, input/output (I/O) interface 506, and audio/video input/output devices 514.

Processor 502 can be one or more processors and/or processing circuits to execute program code and control basic operations of the device 500. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 504 is provided in device 500 for access by the processor 502, and may be any suitable computer-readable or processor-readable storage medium, e.g., random access memory (RAM), read-only memory (ROM), Electrical Erasable Read-only Memory (EEPROM), Flash memory, etc., suitable for storing instructions for execution by the processor, and located separate from processor 502 and/or integrated therewith. Memory 504 can store software operating on the server device 500 by the processor 502, including an operating system 508, one or more applications 510, and a database 512 that may store data used by the components of device 500.

Database 512 may store one or more mechanisms, including human body models that are used for pose tracking and avatar animation in a virtual space. In some implementations, database 512 may store human models in association with different virtual experiences, such as avatars for virtual reality (VR), augmented reality (AR) applications, gaming environments, and interactive user interfaces. The models can include different body types, skeletal configurations, and inverse kinematics (IK) chains to support realistic movement simulation. For instance, in a virtual gaming experience, the database might store avatars for diverse characters that are controlled by upper body tracking inputs. In some implementations, database 512 may store other data relevant to body tracking, such as lookup tables for bone length rescaling, configurations for procedural animation systems, and parameters used for temporal smoothing. In some implementations, applications 510 can include instructions that enable processor 502 to execute the described techniques, such as managing the neural network-based pose estimation, processing 2D keypoints, and triggering confidence-based body detection as described with respect to FIG. 4.

For example, applications 510 can include a module that implements one or more neural network models used in the techniques described herein, such as a backbone, 3D head, or temporal smoothing layers. Applications 510 can integrate confidence prediction mechanisms that determine joint visibility and accuracy, triggering body detection or refining motion predictions based on the confidence scores. The applications can employ one or both of the loss functions described, including a) a pairwise difference between the predicted 3D upper body joint positions and the groundtruth 3D joint positions, and/or b) confidence-weighted loss values to adjust predictions based on joint reliability. Database 512 (and/or other connected storage) can store various data used in the described techniques, including input video frames, bounding boxes, 2D keypoints, 3D pose estimations, confidence scores, and parameters used for avatar animation such as rescaled bone lengths and inverse kinematics configurations.

Elements of software in memory 504 can alternatively be stored on any other suitable storage location or computer-readable medium. In addition, memory 504 (and/or other connected storage device(s)) can store instructions and data used in the features described herein. Memory 504 and any other type of storage (magnetic disk, optical disk, magnetic tape, or other tangible media) can be considered “storage” or “storage devices.”

I/O interface 506 can provide functions to enable interfacing the server device 500 with other systems and devices. For example, network communication devices, storage devices (e.g., memory and/or data store 120), and input/output devices can communicate via interface 506. In some implementations, the I/O interface can connect to interface devices including input devices (keyboard, pointing device, touchscreen, microphone, camera, scanner, etc.) and/or output devices (display device, speaker devices, printer, motor, etc.).

The audio/video input/output devices 514 can a variety of devices including a user input device (e.g., a mouse, etc.) that can be used to receive user input, audio output devices (e.g., speakers), and a display device (e.g., screen, monitor, etc.) and/or a combined input and display device, which can be used to provide graphical and/or visual output.

For ease of illustration, FIG. 5 shows one block for each of processor 502, memory 504, I/O interface 506, and software blocks of operating system 508 and virtual experience application 510. The blocks may represent one or more processors or processing circuitries, operating systems, memories, I/O interfaces, applications, and/or software engines. In other implementations, device 500 may not have all of the components shown and/or may have other elements including other types of elements instead of, or in addition to, those shown herein. While the online virtual experience server 102 is described as performing operations as described in some implementations herein, any suitable component or combination of components of online virtual experience server 102, client device 110, or similar system, or any suitable processor or processors associated with such a system, may perform the operations described.

Device 500 can be a server device or client device. Example client devices or user devices can be computer devices including some similar components as the device 500, e.g., processor(s) 502, memory 504, and I/O interface 506. An operating system, software and applications suitable for the client device can be provided in memory and used by the processor. The I/O interface for a client device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices 514, for example, can be connected to (or included in) the device 500 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein (e.g., method 200 and other described techniques) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, the particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, blocks, operations, or computations may be presented in a specific order, the order may be changed in different particular implementations. In some implementations, multiple steps or operations shown as sequential in this specification may be performed at the same time.

1. A computer-implemented method comprising:
obtaining a video including a plurality of video frames depicting movement of a human subject;
extracting two-dimensional (2D) images of the human subject from the video frames;
providing the 2D images as input to a pre-trained neural network model;
determining a pose of the human subject based on the 2D images, wherein each pose comprises respective 2D positions for a plurality of upper body joints of the human subject;
generating, by the pre-trained neural network model and based on the respective 2D positions, a three-dimensional (3D) pose estimation of respective 3D positions of the plurality of upper body joints of the human subject;
determining confidence scores for the plurality of upper body joints in the 3D pose estimation, the confidence scores representing a prediction accuracy of the respective 3D positions of the plurality of upper body joints;
selecting a plurality of keypoints of the upper body joints of the human subject based on the confidence scores;
animating a 3D avatar using at least the selected plurality of keypoints, wherein the animation comprises transforming coordinates of the estimated 3D positions of the upper body joints to coordinates of corresponding joints of the 3D avatar; and
displaying the animated 3D avatar in a user interface.

2. The method of claim 1, wherein the animated 3D avatar mimics movements of the human subject without user-perceptible lag based on the 3D pose estimation.

3. The method of claim 1, further comprising:
applying temporal smoothing to the 3D pose estimations across consecutive video frames of the plurality of video frames.

4. The method of claim 1, further comprising:
prior to providing the 2D image as input to the pre-trained neural network model, calibrating the 2D image to account for camera distortions.

5. The method of claim 1, further comprising:
triggering a re-detection of the upper body joints of the human subject in the video if the confidence scores fall below a predefined threshold.

6. The method of claim 1, wherein joint positions of the 3D avatar are scaled to match body proportions of the human subject.

7. The method of claim 1, wherein the pre-trained neural network model uses an attention mechanism to focus on keypoints of the upper body joints of the human subject during 3D pose estimation.

8. A system comprising:
one or more processors; and
memory coupled to the one or more processors storing instructions that, when executed by the one or more processors, cause the system to perform operations comprising:
obtaining a video including a plurality of video frames depicting movement of a human subject;
extracting two-dimensional (2D) images of the human subject from the video frames;
providing the 2D images as input to a pre-trained neural network model;
determining a pose of the human subject based on the 2D images, wherein each pose comprises respective 2D positions for a plurality of upper body joints of the human subject;
generating, by the pre-trained neural network model and based on the respective 2D positions, a three-dimensional (3D) pose estimation of respective 3D positions of the plurality of upper body joints of the human subject;
determining confidence scores for the plurality of upper body joints in the 3D pose estimation, the confidence scores representing a prediction accuracy of the 3D positions of the plurality of upper body joints;
selecting a plurality of keypoints of the upper body joints of the human subject based on the confidence scores;
animating a 3D avatar using at least the selected plurality of keypoints, wherein the animation comprises transforming coordinates of the estimated 3D positions of the upper body joints to coordinates of corresponding joints of the 3D avatar; and
displaying the animated 3D avatar in a user interface.

9. The system of claim 8, wherein the animated 3D avatar mimics movements of the human subject without user-perceptible lag based on the 3D pose estimation.

10. The system of claim 8, wherein the instructions cause the system to further perform an operation comprising:
applying temporal smoothing to the 3D pose estimations across consecutive video frames of the plurality of video frames.

11. The system of claim 8, wherein the instructions cause the system to further perform an operation comprising:
prior to providing the 2D image as input to the pre-trained neural network model, calibrating the 2D image to account for camera distortions.

12. The system of claim 8, wherein the instructions cause the system to further perform an operation comprising:
triggering a re-detection of the upper body joints of the human subject in the video if the confidence scores fall below a predefined threshold.

13. The system of claim 8, wherein joint positions of the 3D avatar are scaled to match body proportions of the human subject.

14. The system of claim 8, wherein the pre-trained neural network model uses an attention mechanism to focus on keypoints of the upper body joints of the human subject during 3D pose estimation.

15. A non-transitory computer-readable medium with instructions stored thereon that, when executed by a processor, cause the processor to perform operations comprising:
obtaining a video including a plurality of video frames depicting movement of a human subject;
extracting two-dimensional (2D) images of the human subject from the video frames;
providing the 2D images as input to a pre-trained neural network model;
determining a pose of the human subject based on the 2D images, wherein each pose comprises respective 2D positions for a plurality of upper body joints of the human subject;
generating, by the pre-trained neural network model and based on the respective 2D positions, a three-dimensional (3D) pose estimation of respective 3D positions of the plurality of upper body joints of the human subject;
determining confidence scores for the plurality of upper body joints in the 3D pose estimation, the confidence scores representing a prediction accuracy of the 3D positions of the plurality of upper body joints;
selecting a plurality of keypoints of the upper body joints of the human subject based on the confidence scores;
animating a 3D avatar using at least the selected plurality of keypoints, wherein the animation comprises transforming coordinates of the estimated 3D positions of the upper body joints to coordinates of corresponding joints of the 3D avatar; and
displaying the animated 3D avatar in a user interface.

16. The non-transitory computer-readable medium of claim 15, wherein the animated 3D avatar mimics movements of the human subject without user-perceptible lag based on the 3D pose estimation.

17. The non-transitory computer-readable medium of claim 15, wherein the instructions further cause the processor to perform an operation comprising:
applying temporal smoothing to the 3D pose estimations across consecutive video frames of the plurality of video frames.

18. The non-transitory computer-readable medium of claim 15, wherein the instructions further cause the processor to perform an operation comprising:
prior to providing the 2D image as input to the pre-trained neural network model, calibrating the 2D image to account for camera distortions.

19. The non-transitory computer-readable medium of claim 15, wherein the instructions further cause the processor to perform an operation comprising:
triggering a re-detection of the upper body joints of the human subject in the video if the confidence scores fall below a predefined threshold.

20. The non-transitory computer-readable medium of claim 15, wherein joint positions of the 3D avatar are scaled to match body proportions of the human subject.
